(19) United States
(12) Patent Application Publication
(10) Pub. No.: US 2009/0129134 A1
(43) Pub. Date: May 21, 2009

(54) CONTROLLED CLASS-E DC AC CONVERTER

(75) Inventors: PATRICK JOHN ZIJLSTRA, EINDHOVEN (NL); WINSTON DONALD COUWENBERG, EINDHOVEN (NL); RENE VAN HONSCHOOTEN, EINDHOVEN (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/066,528

(22) PCT Filed: Sep. 7, 2006
(86) PCT No.: PCT/IB06/53151

§ 371 Date: Mar. 12, 2008

(30) Foreign Application Priority Data
Sep. 12, 2005 (EP) 05108320.2

(51) Int. Cl. H02M 7/537

(52) U.S. Cl. 363/131

(57) ABSTRACT

Converting a direct (DC) input voltage supplied by a DC source (2) to an alternating (AC) output voltage, comprising supplying the DC input voltage through an inductor (8) to a series connection of a resonant circuit (10, 12, 16, 18) and a load (6), switching the voltage supplied to the series connection, resonant circuit (10, 12, 16, 18) and load (6) alternately on and off, wherein the input voltage is controlled to constitute a DC voltage with a controlled magnitude, in particular by arranging a DC-DC buck converter, which is connected to the DC source (2) and which comprises a second switch (22) and a freewheeling diode (24), the latter being connected parallel to the series connection of the inductor (8), the resonant circuit (10, 12, 16, 18) and the load (6).

### FIELD OF THE INVENTION

The invention relates to a method for converting a direct (DC) input voltage to an alternating (AC) output voltage as described in the preamble of claim 1 and to a class-E DC-AC converter as described in the preamble of claim 4.

### BACKGROUND OF THE INVENTION

U.S. Pat. No. 6,008,589, in particular with reference to FIG. 5a thereof, discloses a DC-AC conversion method and a class-E DC-AC converter of the above type.

The load of the converter is a lamp.

For controlling a power supplied to the load it is proposed to control the frequency by which a switch of the converter is alternately turned on and off and/or to apply switched capacitors to the resonant circuit of the converter. In both cases the frequency with which the switch is turned on and off must be about the resonant frequency of the resonant circuit. This limits the available frequency range and therewith the range of the controlled output power. Yet, if the lamp is a high pressure discharge (HID) lamp, the frequency range may well exceed a so-called acoustic resonance free window, beyond which the discharge arc may vibrate due to a pressure wave inside the lamp. Because the pressure wave is related to the switching frequency of the class-E DC-AC converter, the light output may become unstable and the lamp may even explode. Such a window may be as small as 5 kHz. During normal operation of a HID lamp its impedance is resistive, but its resistance value may vary enormously depending on different conditions, such as its temperature and the current flowing through it. As a consequence, it is very difficult to control the output power for a load through the switching frequency of the switch of the class-E DC-AC converter.

### OBJECT OF THE INVENTION

It is an object of the invention to solve the drawbacks of the prior art as described above.

### SUMMARY OF THE INVENTION

The above object of the invention is achieved by providing a method as described in claim 1.

Accordingly, an average DC voltage supplied to the resonant circuit of the class-E DC-AC converter and thus also the output power can be controlled over a wide range with little effort while, in case the load is a HID lamp, remaining within the acoustic resonance free window.

The above object of the invention is achieved also by providing a class-E DC-AC converter as described in claim 4.

### BRIEF DESCRIPTION OF THE DRAWINGS

The invention will become more gradually apparent from the following exemplary description in connection with the accompanying drawing. In the drawing:

FIG. 1 shows a circuit diagram of a prior art class-E DC-AC converter; and

FIG. 2 shows a circuit diagram of a controlled class-E DC-AC converter according to the invention.

### DETAILED DESCRIPTION OF EXAMPLES

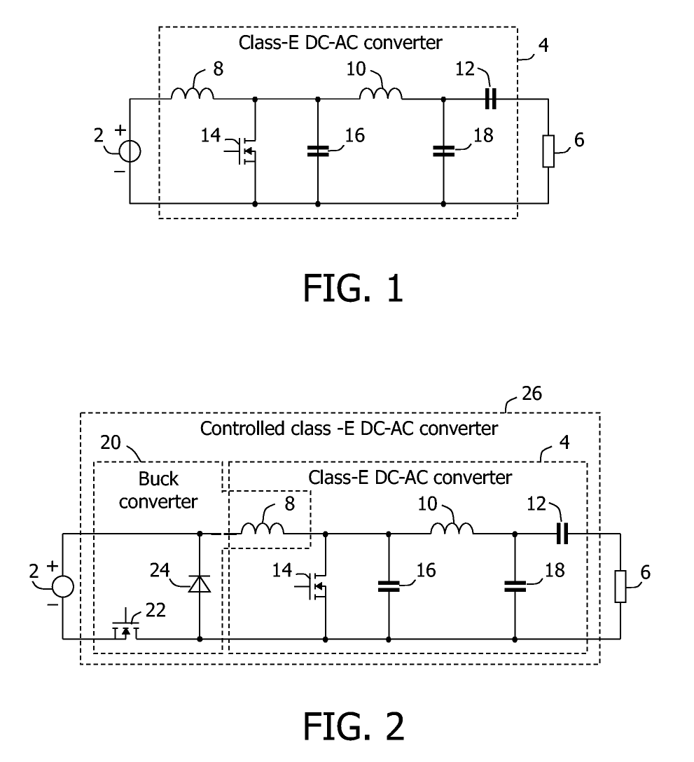

The circuit shown in FIG. 1 comprises a direct voltage (DC) source 2, which is connected to a prior art class-E DC-AC converter 4, which, in turn, is connected to a load 6. The prior art class-E DC-AC converter 4 shown in FIG. 1 is of a basic type, such as disclosed by U.S. Pat. No. 6,008,589 (FIG. 5a thereof). However, the invention is not limited to be used with such a class-E converter.

It is noted that the direct voltage supplied by DC source 2 does not change polarity and that its magnitude may vary, possibly because of rectifying an alternating voltage by one diode only.

The class-E DC-AC converter 4 comprises in series and the following order connected between one terminal, assumingly the positive one of DC source 2, and one terminal of load 6 a choke coil, or more generally, a first inductor 8, a second inductor 10 and a first capacitor 12. The other terminal, assumingly the negative one of DC source 2 and the other terminal of the load 6 are connected to each other. A semiconductor switch 14, which may be a MOSFET, is connected between the negative terminal of DC source 2 and the interconnection between the inductors 8 and 10. A second capacitor 16 is connected in parallel to the switch 14. A third capacitor 18 is connected between the negative terminal of DC source 2 and the interconnection between the second inductor 10 and the first capacitor 12.

The second inductor 10 and the three capacitors 12, 16, 18 constitute a resonant circuit.

The first inductor 8 is mainly for maintaining a current flowing through the node between the inductors 8 and 10 when switch 14 is turned on or off.

During normal operation of the circuit shown in FIG. 1 switch 14 is turned on and off regularly by supplying it with a clock signal. The frequency of the clock signal is matched to the resonant frequency of the resonant circuit. As a result, an alternating current (AC) will be generated by the converter 4 and supplied to the load 6.

If the load 6 is a high pressure gas discharge (HID) lamp, while conducting, the lamp behaves like a resistor. However, the resistance of the lamp may vary enormously for different reasons, one of which being its temperature and therefore the current flowing through the lamp. If such variation of resistance of the lamp would be ignored, the light output would also vary enormously. To avoid such variation of the light output, a power control is needed. With prior art power controllers an output voltage across load (lamp) 6 and a current through load 6 is measured, a product thereof is compared to a reference value to provide an error and dependent on a value of the error, the frequency of the clock signal supplied to switch 14 is changed, such that the error is decreased. With some prior art power controllers the resonant frequency of the resonant circuit 4 is changed by connecting or not in parallel to one or several capacitors 12, 16, 18 an additional capacitor by controlling an electronic switch in series with said additional capacitor.

With the load being a HID lamp, changing the frequency of the clock signal to switch 14 to control an output power to the lamp 6 may well lead to exceeding a so-called acoustic resonance free frequency window. With a clock frequency beyond such window the discharge arc of the HID lamp may vibrate, the light output may become unstable and the lamp may even explode. Dependent on the lamp type, an acoustic resonance free window may be as small as 5 kHz. It will be clear that this makes it very difficult to provide a power controller which is suitable within a practical range of conditions of the lamp.

Changing the resonance frequency by connecting or disconnecting reactive components to or from the resonant circuit has the additional drawback to increase costs.

To solve the drawbacks mentioned above, according to the invention a DC voltage supplied to the class-E DC-AC converter 4 is controlled dependent on the error between the measured output power and a reference value.

Accordingly, the diagram shown in FIG. 2 comprises a DC-DC down converter or buck converter 20. The buck converter 20 comprises a switch 22, such as a MOSFET, which is connected in series with the class-E DC-AC converter 4 to the DC source 2, a diode 24, which is connected in parallel to the class-E DC-AC converter 4, with the cathode of the diode connected to the first inductor 8, and the first inductor 8 of the class-E DC-AC converter 4. The class-E DC-AC converter 4 together with the buck converter 20 form a controlled class-E DC-AC converter 26 according to the invention.

The switch 22 is controlled by a pulse control signal which is supplied by a controller (not shown). The frequency of the control signal may differ from the frequency of the clock signal to the first switch 14. A duty cycle of the control signal is made dependent on the error (sign inclusive) between a measured output power value and a reference value.

When the second switch 22 is turned on, a current will flow through the DC source 2, the class-E converter 4 and the load 6. When the second switch 22 is turned off subsequently, by virtue of diode 24 a current is maintained to flow through the class-E converter 4 and the load 6. Therefore, diode 24 is called a freewheeling diode. The remained current will decrease though, until the second switch is turned on again. Therefore, addition of the second switch 22 and the diode 24 is practical only because these elements are connected to a circuit, in particular the class-E converter 4, which comprises a current sustaining element, in particular the already present first inductor 8, to therewith provide a buck converter 20.

By changing the duty cycle of the control signal to the second switch 22 dependent on the error, a DC voltage across the diode 24 is changed, such that the output voltage, the output current and the output power of the class-E converter change accordingly. The duty cycle of the control signal is changed such as to decrease the error, that is, at least on average during some time, dependent on a continuous or discontinuous mode of operation of the down converter.

With the controlled class-E converter 26 according to the invention, the resonance frequency of the resonant circuit 10, 12, 16, 18 doesn't need to be changed for controlling an output power supplied to load 6. This improvement is obtained by little effort, in particular by providing a simple buck converter 20 at the input of a classic class-E converter 4.

The improvement for controlling the output power during steady state operation of the circuit also allows to generate a higher run-up current during a starting period of a HID lamp being load 6 in the illustrated circuits.

It must be observed that, without departing from the scope of the invention as defined by the accompanied claims, a skilled person may apply different modifications. For example, the class-E DC-AC converter 4 may have a different configuration, such as comprising a transformer, and the buck converter 20 may be provided with its own inductor, in series with the inductor 8 of the already present first inductor 8. Also, the second switch 22 may be connected to the other (positive) terminal of the DC source 2 than shown.

1-7. (canceled)

8. A class-E DC-AC converter (26), comprising:
a resonant circuit (10, 12, 16, 18), of which an output is connected to a load (6),
an inductor (8), which is coupled in series with the resonant circuit to a direct current voltage (DC) source (2), and
a first switch (14), which is connected parallel to the resonant circuit (10, 12, 16, 18), wherein at the input of the class-E converter (26) there is arranged a controlled DC-DC converter for controlling an average DC voltage supplied from the DC source (2) through the inductor (8) to the resonant circuit (10, 12, 16, 18),
wherein the inductor (8) is part of the controlled DC-DC converter.

9. A class-E DC-AC converter (26) according to claim 8, characterized in that the DC-DC converter comprises a second switch (22), which is connected to the DC source (2) in series with the inductor (8), and a freewheeling diode (24), which is coupled to the second switch (22), parallel to the series connection of the inductor (8), the resonant circuit (10, 12, 16, 18) and the load 6.

10. The class-E DC-AC converter (26) according to claim 8, comprising a controller for controlling the controlled DC-DC converter dependent on a measured error between a measured output power of the load (6) and a reference value.

11. The class-E DC-AC converter (26) according to claim 10, wherein the controller supplies a pulse control signal to the second switch (22), wherein a duty cycle of the pulse control signal is dependent on the measured error between the measured output power and the reference value.

12. The class-E DC-AC converter (26) according to claim 8, the controlled DC-DC converter comprises a down converter.

13. A class-E DC-AC converter (26) according claim 8, characterized in that the second switch (22) is adapted to be switched on and off at an on-off ratio that is dependent on a desired power to be supplied to the load (6).

14. A method for converting a direct (DC) input voltage to an alternating (AC) output voltage, comprising:
supplying the DC input voltage to an inductor (8) which is connected in series to a resonant circuit (10, 12, 16, 18);
switching the voltage supplied through the inductor (8) alternately on and off by a first switch which is connected in parallel to the resonant circuit;
supplying the switched voltage to the resonant circuit (10, 12, 16, 18) connected to a load (6),
wherein the voltage supplied to the inductor is controlled to constitute a DC voltage with a controlled magnitude, and
wherein the inductor (8) is part of a controlled DC-DC converter for controlling the voltage supplied to the inductor.

15. A method according to claim 14, characterized in that controlling the voltage supplied to the inductor comprises switching the DC input voltage alternately on and off and maintaining a current flowing through the inductor (8) when the input voltage is switched off.

16. A method according to a claim 15, characterized in that switching the DC input voltage is done with an on-off ratio that is dependent on a desired power to be supplied to the load (6).

17. A method according to claim 14, comprising the steps of:
measuring an output power;
measuring an error between the measured output power and a reference value;
supplying a pulse control signal to a second switch (22) of the controlled DC-DC converter,
changing a duty cycle of the pulse control signal dependent on the measured error between the measured output power and the reference value.
